(19) United States
(12) Patent Application Publication
(10) Pub. No.: US 2012/0091384 A1
(43) Pub. Date: Apr. 19, 2012

(54) FLAT GASKET

(75) Inventor: Jens Hoppe, Erlangen (DE)

(73) Assignee: SCHAEFFLER TECHNOLOGIES GMBH & CO. KG, (DE)

(21) Appl. No.: 13/378,836

(22) PCT Filed: Jun. 4, 2010
(86) PCT No.: PCT/EP10/57817

§ 371 Date: Dec. 16, 2011

(30) Foreign Application Priority Data
Jul. 4, 2009 (DE) 10 2009 031 710.4

(51) Int. Cl. F16K 1/48

(52) U.S. Cl. 251/357

(57) ABSTRACT

A flat gasket arranged between a component that is fixed to the cylinder head and a housing that accommodates a camshaft adjuster. The flat gasket has a flat gasket body encompassing a surface to be sealed. On the gasket body, a convexity is formed, which encompasses the surface to be sealed and protrudes from the surface of the gasket body.

### FIELD OF THE INVENTION

The invention relates to a flat gasket which is arranged between a component which is fixed to the cylinder head and a housing which accommodates a camshaft adjuster, having a flat sealing body which engages around a face to be sealed, a bulge which runs around the face to be sealed and protrudes out of the surface of the sealing body being formed on the sealing body.

### BACKGROUND OF THE INVENTION

In modern internal combustion engines, camshaft adjusters are used, in order for it to be possible to configure the phase relation between the crankshaft and the camshaft variably in a defined angular range, between a maximum early position and a maximum late position. For this purpose, the camshaft adjuster is integrated into a drive train, via which torque is transmitted from the crankshaft to the camshaft. This drive train can be realized, for example, as a belt drive, chain drive or gearwheel drive. Camshaft adjusters of this type arc configured as a rule as hydraulic pivoting motors, for example of vane cell design or axial piston design, having at least two pressure chambers which act counter to one another. Here, the pressure medium feed to and the pressure medium discharging from the pressure chambers are controlled by means of a hydraulic directional valve, for example a proportional valve.

DE 42 18 078 C1 has disclosed a camshaft adjuster of axial piston design which is arranged within a housing which is fastened to a cylinder head. The housing and the cylinder head have aligned openings which are reached through by the camshaft adjuster and a camshaft which is mounted in the cylinder head. Here, the camshaft is connected fixedly to an output element of the camshaft adjuster so as to rotate with it. The housing has a pressure medium channel which communicates with a pressure medium channel which is formed in the cylinder head and a control valve which is accommodated in the housing. Pressure medium from a pressure medium pump of the internal combustion engine can therefore be distributed via the pressure medium channels and the control valve to the pressure chambers of the camshaft adjuster.

The housing bears flatly against the cylinder head in the region which reaches around the opening. Here, the region of the openings of the housing and of the cylinder head and the region of the pressure medium channels are sealed with respect to the surroundings by means of a plurality of O-ring seals. The O-ring seals reach around the faces to be sealed and therefore prevent the escape of pressure medium, usually lubricant of the internal combustion engine.

During the operation of the internal combustion engine, the cams of the camshaft actuate the gas exchange valves. Here, in the case of running onto a earn, the gas exchange valves are opened counter to the force of a valve spring and, in the case of running off from a cam, are closed by the valve spring. The opening and closing forces result in oscillating alternating torques which act on the camshaft and for their part in turn generate pressure peaks in the pressure chambers of the camshaft adjuster. In order to prevent the propagation of said pressure peaks into the lubricant circuit of the internal combustion engine, DE 10 2007 056 683 A1 has disclosed, for example, positioning a nonreturn ball valve in the pressure medium channel upstream of the control valve, which nonreturn ball valve permits a flow of pressure medium to the control valve, but shuts off a flow of pressure medium which is directed in the opposite direction. This prevents pressure peaks being propagated into the lubricant system of the internal combustion engine and damaging further connected consumers. Moreover, an undesired outflow of pressure medium out of the pressure chambers of the camshaft adjuster is prevented, as a result of which its adjusting speed is increased and phase fluctuations are avoided.

Disadvantages of the known solutions are the high installation space requirement and the high costs of the nonreturn valve and the complicated seal of the contact point between the cylinder head and the housing which accommodates the camshaft adjuster.

### Object of the Invention

The invention is based on the object of reducing the costs, the installation space requirement and the assembly outlay of an internal combustion engine with a camshaft adjuster which is accommodated in a housing which is fastened to the cylinder head.

### Achievement of the Object

According to the invention, the object is achieved by the fact that a closing element is provided which is connected to the sealing body and is arranged in the region which is engaged around by the circumferential bulge, it being possible for the closing element to be pivoted toward the plane of the sealing body and out of the latter, and it being possible for a channel opening to be closed by means of the closing clement in a manner which is tight with respect to pressure medium, which channel opening is formed in the housing or the component which is fixed to the cylinder head.

The flat gasket is arranged between the housing and a component which is fixed to the cylinder head, in the region of an opening of the component which is fixed to the cylinder head. The housing likewise has an opening in the region of the opening of the component which is fixed to the cylinder head. The component which is fixed to the cylinder head can be, for example, the cylinder head itself, a cylinder head cover or a crankcase of the internal combustion engine. The housing can be, for example, of cup-shaped configuration. The camshaft adjuster is arranged in a receptacle of the housing and is encapsulated by means of the housing and the component which is fixed to the cylinder head. The openings of the housing and of the component which is fixed to the cylinder head are reached through by a camshaft and/or a component of the camshaft adjuster, said components being drive-connected to one another.

A first pressure medium channel is formed within the housing or the component which is fixed to the cylinder head, which first pressure medium channel has a channel opening on that bounding face of the component which faces the other component. Moreover, a second pressure medium channel is formed on the housing or the component which is fixed to the cylinder head, which second pressure medium channel likewise has a channel opening on that bounding face of the component which faces the other component, and which second pressure medium channel can communicate hydraulically with the first pressure medium channel. Pressure medium can be guided to the camshaft adjuster via the pressure medium channels.

During the operation of the internal combustion engine, there is pressure medium or lubricant in the regions of the channel openings and of the openings. The contact face between the housing and the component which is fixed to the cylinder head, which contact face surrounds the openings and channel openings, therefore has to be sealed with respect to the surroundings. For this purpose, the flat gasket has a flat sealing body, for example a metal sheet which engages around the surfaces to be sealed. Here, the flat sealing body is of substantially planar configuration with a considerably smaller thickness in comparison with the other extents. At least one bulge which runs around the surfaces to be sealed and protrudes out of the surface of the sealing body is provided on the sealing body. During the fastening of the housing to the component which is fixed to the cylinder head, the bulge is compressed elastically, as a result of which it bears under stress against both components and the sealing function is produced between the components.

A closing element which is connected to the sealing body and can be pivoted toward the plane of the sealing body and out of the latter is provided in the region of the first pressure medium channel. The closing element can be configured, for example, as a flat sheet metal component, it being possible for its plane to be arranged parallel to or perpendicularly with respect to the plane of the sealing body. Here, the closing element is configured and arranged in such a way that it can be pivoted into a position, in which it closes the channel opening of the first pressure medium channel in a pressuretight manner. If the pressure in the second pressure medium channel is higher than the pressure in the first pressure medium channel, a force acts on the closing element, which force pushes said closing element against the channel opening of the first pressure medium channel and therefore closes said channel opening. This movement is assisted by the spring force of the closing element. A flow of pressure medium from the second pressure medium channel into the first pressure medium channel is therefore suppressed. In a reverse pressure configuration, the closing element raises up from the channel opening, as a result of which pressure medium can flow out of the first pressure medium channel to the second pressure medium channel. The closing element and the channel opening therefore form a nonreturn valve. As a result of the integration of the closing element into the flat gasket, no separate nonreturn valve is required, which has a positive effect on the costs. Moreover, the assembly outlay and faulty assembly are reduced, since the nonreturn valve is installed with the flat gasket.

It is proposed in one development of the invention that the closing element has a closing body for closing the channel opening and a spring tongue, the spring tongue being connected to the sealing body and the closing body being connected to the spring tongue. The closing element can be configured, for example, as a flexible paddle, the widened region of the paddle serving as a closing body for shutting the channel opening of the pressure medium channel. The (closing) spring force which acts on the closing body and therefore the response pressure can be set via the spring tongue. The spring force can be reduced by a longer, thinner and/or narrower spring tongue and can be increased by a shorter, thicker and/or wider spring tongue. It can be provided here that, in the region of the channel opening, the closing body can be brought into contact with the component which is fixed to the cylinder head or with the housing. An inexpensive nonreturn valve is therefore realized by the channel opening, the closing body and the spring tongue.

Moreover, it can be provided that a stop for the closing body is formed on the housing and/or the component which is fixed to the cylinder head. The stop limits the deflection travel of the closing element/closing body away from the channel opening. This prevents the closing element bending during the operation of the internal combustion engine.

Furthermore, it can be provided that the closing element/the closing body and the spring tongue are configured in one piece with the sealing body.

As a result of the single-piece configuration of the closing body with the spring tongue and of the spring tongue or the closing element with the sealing body of the flat gasket, they can be formed inexpensively from the material of the sealing body.

The closing element which is configured in one piece with the sealing body can be formed by the material of the sealing body being cut along a line which is not closed. Inexpensive sheet metal machining methods, for example punching methods, can therefore be used to produce the closing element.

It can be provided in one development of the invention that the closing element protrudes out of the plane of the sealing body in the region of the channel opening. In this case, the first pressure medium channel opens into a cutout of the component which accommodates it. When the first pressure medium channel is pressureless, the closing element which is connected to the sealing body extends out of the plane of the sealing body into the cutout and bears against the channel opening of the first pressure medium channel.

As an alternative, it can be provided that the sealing body has a passage opening, in which the closing element is arranged. This embodiment is suitable for use in applications, in which pressure medium is to be exchanged between a pressure medium channel which is formed in the component which is fixed to the cylinder head and a pressure medium channel which is formed in the housing. In order to make the pressure medium transfer possible, a passage opening is formed on the sealing body in the region of the two pressure medium channels, in which passage opening a closing element is arranged. Here, the closing element can be formed in a manner which is cut from the sealing body in the plane of the sealing body along a line which is not closed. The closing element is therefore connected to the sealing body merely along a short distance in comparison with its entire circumference, the non-connected part of the closing element being configured such that it can be pivoted out of the plane of the sealing body.

### BRIEF DESCRIPTION OF THE DRAWINGS

Further features of the invention result from the following description and from the drawings, in which exemplary embodiments of the invention are shown in simplified form and in which:

FIG. 1 shows a plan view of a first flat gasket according to the invention,

FIG. 2 shows a sectional illustration along the line 11-11 from FIG. 1,

FIG. 3 shows the first flat gasket according to the invention in the installed state, the channel opening being blocked,

FIG. 4 shows the first flat gasket according to the invention in the installed state, the channel opening being open, and

FIG. 5 shows a second flat gasket according to the invention in the installed state, the channel opening being open.

### DETAILED DESCRIPTION OF THE DRAWINGS

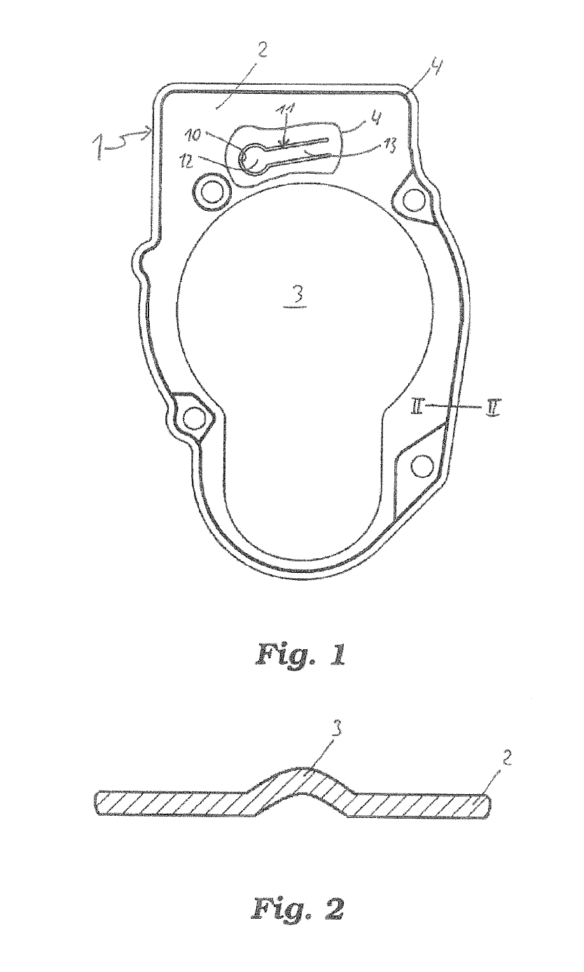

FIG. 1 shows a flat gasket 1 according to the invention in plan view. The flat gasket 1 consists of a flat sealing body 2 which encloses a face 3 to be sealed. The flat sealing body 2 extends in one plane, the thickness being of considerably smaller configuration in comparison with the other spatial dimensions, A bulge 4 which runs around the face 3 to be sealed and protrudes out of the plane of the sealing body 2 (FIG. 2) is formed on the sealing body 2 which is produced from a metal sheet, for example a steel sheet.

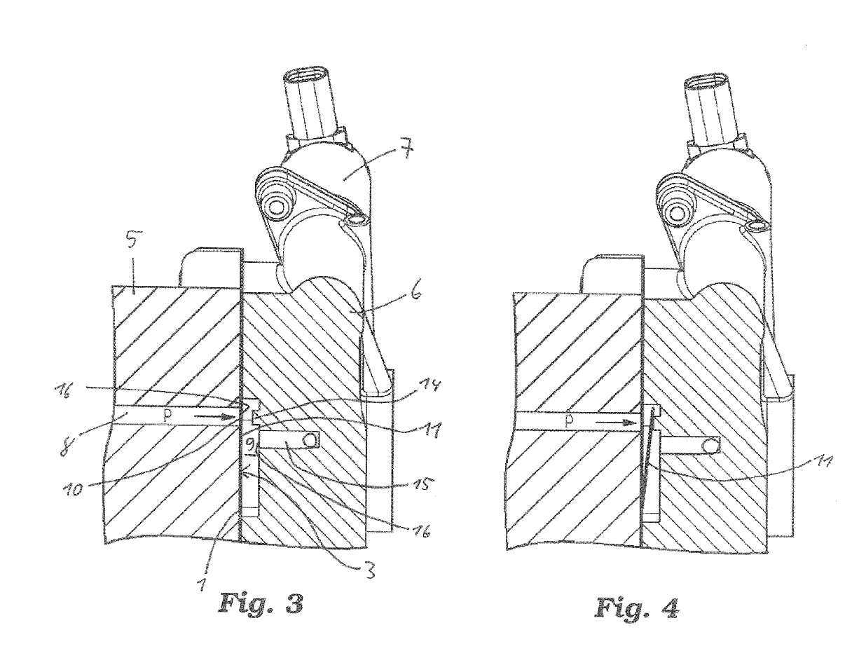

FIGS. 3 and 4 show the flat gasket 1 in its installed state. The flat gasket 1 is arranged between a cylinder head 5 of an internal combustion engine and a housing 6. The housing 6 accommodates a camshaft adjuster (not shown) and a hydraulic proportional valve 7 for controlling the pressure medium flows from and to the camshaft adjuster and is connected fixedly to the cylinder head 5, for example by means of screw connections. As a result of the assembly forces, the bulge 4 is set back elastically in the direction of the plane of the sealing body 2. The sealing body 2 therefore bears under stress both against the cylinder head 5 and against the housing 6 in the region of the bulges 4, as a result of which said components are connected to one another within the bulge 4 in a manner which is tight with respect to pressure medium. Here, the sealing body 2 can be provided with a coating, for example an elastomer coating, at least in the region of the bulges 4, in order to increase the sealing action.

A first pressure medium channel 8 which communicates with a pressure medium pump (not shown) of the internal combustion engine is formed within the cylinder head 5. The housing-side channel opening 16 of the first pressure medium channel 8 lies opposite a cutout 9 of the housing 6. A passage opening 10, in which a closing element 11 is arranged, is formed on the flat gasket 1 in the region of the cutout 9. The closing element 11 does not have a coating, comprises a closing body 12 and a spring tongue 13 and is configured in one piece with the sealing body 2. In its rest position, the closing element 11 is arranged in the plane of the sealing body 2 and is configured such that it can be pivoted by means of a force out of this plane into the cutout 9. Here, a stop 14 which is arranged in the cutout 9 limits the maximum possible deflection travel of the closing element 11.

During the operation of the internal combustion engine, pressure medium is conveyed by the pressure medium pump via the first pressure medium channel 8 to the closing body 12. As a result of the pressure which prevails at the closing body 12, the latter is pushed against the stop 14. The pressure medium therefore passes through the passage opening 10 into the cutout 9 and via a second pressure medium channel 15 to the camshaft adjuster, the second pressure medium channel 15 opening via a channel opening 16 into the cutout 9.

As a result of the deflection of the closing element 11, the spring tongue 13 is likewise pivoted out of its rest position, as a result of which a restoring force acts on the closing body 12. If the pressure in the second pressure medium channel 15 exceeds the pressure in the first pressure medium channel 8, the closing element 11 is set back into the plane of the sealing body 2 as a result of the restoring force of the spring tongue 13 and the pressure difference, until the closing body 12 comes into contact with the cylinder head 5 and closes the channel opening 16 of the first pressure medium channel 8. The closing element 11 and the channel opening 16 of the first pressure medium channel 8 therefore form a nonreturn valve which prevents a backflow of pressure medium out of the camshaft adjuster into the first pressure medium channel 8.

A second bulge 4 which runs around the closing element 11 is provided on the sealing body 2, with the result that both the first pressure medium channel 8 and the cutout 9 are sealed with respect to the face 3 to be sealed.

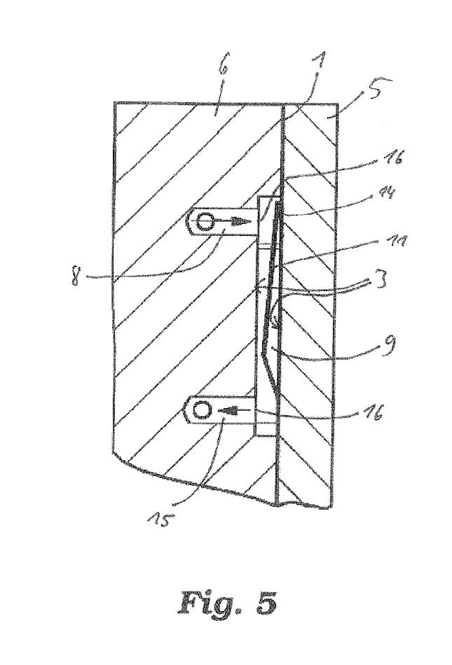

FIG. 5 shows a second embodiment according to the invention of a flat gasket 1 in the installed state. Here, in contrast to the first embodiment, that region of the spring tongue 13 which is connected to the sealing body 2 is bent out of the plane of the sealing body 2 into the cutout 9. The closing body 12 therefore bears against the housing 6 and closes a channel opening 16 of a first pressure medium channel 8 which is formed in the housing 6. The closing body 12 is pushed back into the cutout 9 by the pressure in the first pressure medium channel 8. A flow of pressure medium to a second pressure medium channel 15 which is likewise formed in the housing 6 is therefore permitted. If the pressure in the second pressure medium channel 15 exceeds the pressure in the first pressure medium channel 8, the spring tongue 13 pushes the closing body 12 against the channel opening 16 of the first pressure medium channel 8, as a result of which a backflow of pressure medium into the first pressure medium channel 8 is suppressed. The nonreturn valve can therefore also act between pressure medium channels 8, 15 which are formed in the same component (housing 6 or cylinder head 5).

Embodiments are also conceivable, in which both embodiments of a closing element 11 are formed on a flat gasket 1. In the case of a housing which, in addition to the camshaft adjuster and the proportional valve 7, accommodates a pressure accumulator which is arranged upstream of the proportional valve 7, the first embodiment of a closing element 11 can permit a flow of pressure medium from the cylinder head 5 into the pressure accumulator and shut off a backflow, as a result of which the pressure accumulator remains filled even in the case of a falling system pressure. The second embodiment of a closing element 11 can be arranged between the pressure accumulator and the proportional valve 7, a flow of pressure medium to the proportional valve 7 being permitted and a backflow being shut off. Pressure peaks which are generated in the camshaft adjuster therefore cannot be propagated into the pressure accumulator.

The closing element 11 can be produced, for example, by being punched from a flat section of the sealing body 2 along a line which is not closed. The sealing body 2 can be configured, for example, as a metal plate. The shape can be produced, for example, by means of chipless forming methods, for example punching and deep drawing or stamping. In the case of the second embodiment, the spring tongue 13 is bent into the desired shape after punching.

The spring constant of the spring tongue 13 can be adapted to the respective requirements by the dimensioning of said spring tongue 13. Longer, thinner and/or narrower spring tongues 13 lead to a lower spring constant, and shorter, thicker and/or wider spring tongues 13 lead to a higher spring constant. The pressure, at which the nonreturn valve opens the throughflow, and the response sensitivity can therefore be set without additional outlay.

In addition to a single-piece configuration of the closing element 11 with the sealing body 2, embodiments are also conceivable, in which the closing element 11 is manufactured separately from the sealing body 2 and is fastened to the latter, for example, by means of a welded, adhesively bonded or soldered connection.

### List of Designations

1 Flat Gasket

2 Sealing Body

3 Face To Be Sealed

4 Bulge

5 Cylinder Head

6 Housing

7 Proportional Valve

8 First pressure Medium Channel

9 Cutout

10 Passage Opening

11 Closing Element

12 Closing Body

13 Spring Tongue

14 Stop

15 Second Pressure Medium Channel

16 Channel Opening

1-8. (canceled)

9. A flat gasket which is arranged between a component which is fixed to a cylinder head and a housing which accommodates a camshaft adjuster, comprising:
a flat sealing body, which engages around a face to be sealed;
a circumferential bulge, formed on the sealing body so as to run around the face to be sealed and protrude out of a surface of the sealing body; and
a closing element connected to the sealing body and arranged in a region that is encompassed by the circumferential bulge, the closing element being pivotable toward a plane of the sealing body and out of the plane of the sealing body so as to close a channel opening of a pressure medium channel, which is formed in the housing or the component that is fixed to the cylinder head, in a manner which is tight with respect to pressure medium.

10. The flat gasket as claimed in claim 9, wherein the closing element has a closing body for closing the channel opening and a spring tongue, the spring tongue being connected to the sealing body and the closing body being connected to the spring tongue.

11. The flat gasket as claimed in claim 10, further comprising a stop for the closing body formed on the housing and/or the component which is fixed to the cylinder head.

12. The flat gasket as claimed in claim 10, wherein the closing body is moveable into contact with the component which is fixed to the cylinder head or with the housing in a region of the channel opening.

13. The flat gasket as claimed in claim 9, wherein the closing element is configured in one piece with the sealing body.

14. The flat gasket as claimed in claim 13, wherein a material of the sealing body is cut along a line which is not closed so as to form the closing element.

15. The flat gasket as claimed in claim 9, wherein the sealing body has a passage opening and the closing element is arranged in the passage opening.

16. The flat gasket as claimed in claim 9, wherein the closing element protrudes out of the plane of the sealing body in a region of the channel opening.
